(19) United States
(12) Patent Application Publication
(10) Pub. No.: US 2009/0061126 A1
(43) Pub. Date: Mar. 5, 2009

(54) Package and Multi-Layer Flexible Film Having Paper Containing Post Consumer Recycled Fiber

(76) Inventors: Anthony Robert Knoerzer, Parker, TX (US); Brad Dewayne Rodgers, Frisco, TX (US)

Correspondence Address: CARSTENS & CAHOON, LLP, P O BOX 802334, DALLAS, TX, 75380, US

(21) Appl. No.: 11/848,775

(22) Filed: Aug. 31, 2007

(51) Int. Cl. B32B 27/10

(52) U.S. Cl. 428/34.3

(57) ABSTRACT

A multi-layer film and package with barrier properties made from a multi-layer film having one or more layers made with paper comprising post consumer reclaimed fibers is disclosed. In one aspect, the print web comprises a paper sheet made from post consumer reclaimed fibers. Unlike prior art petroleum-based films, the inventive film having PCR paper of the present invention is made from a renewable and/or recycled resource and is biodegradable.

### BACKGROUND OF THE INVENTION

1. Technical Field

The present invention relates to a flexible packaging material having post consumer recycled fiber that can be used in packaging and more particularly to a multi-layer film comprising post consumer recycled fiber that can be used to package food products.

2. Description of Related Art

Multi-layered film structures made from petroleum-based products originating from fossil fuels are often used in flexible packages where there is a need for its advantageous barrier, sealant, and graphics-capability properties. Barrier properties in one or more layers are important in order to protect the product inside the package from light, oxygen or moisture. Such a need exists, for example, for the protection of foodstuffs, which may run the risk of flavor loss, staling, or spoilage if insufficient barrier properties are present to prevent transmission of such things as light, oxygen, or moisture into the package. In addition, barrier properties also prevent undesirable leaching of the product to the outside of the bag. For example, oily foods such as potato chips have the potential for some oil to leach out into the film of the bag. The sealant properties are important in order to enable the flexible package to form an airtight or hermetic seal. Without a hermetic seal, any barrier properties provided by the film are ineffective against oxygen, moisture, or aroma transmission between the product in the package and the outside. A graphics capability is needed because it enables a consumer to quickly identify the product that he or she is seeking to purchase, allows food product manufacturers a way to label the nutritional content of the packaged food, and enables pricing information, such as bar codes to be placed on the product.

One prior art multi-layer or composite film used for packaging potato chips and like products is illustrated in FIG. 1 which is a schematic of a cross section of the multi-layer film 100 illustrating each individual substantive layer. Each of these layers functions in some way to provide the need barrier, sealant, and graphics capability properties. For example, the graphics layer 114 is typically used for the presentation of graphics that can be reverse-printed and viewed through a transparent outer base layer 112. Like numerals are used throughout this description to describe similar or identical parts, unless otherwise indicated. The outer base layer 112 is typically oriented polypropylene (“OPP”) or polyethylene terephthalate (“PET”). A metal layer disposed upon an inner base layer 118 provides the required barrier properties. It has been found and is well-known in the prior art that by metalizing a petroleum-based polyolefin such as OPP or PET reduces the moisture and oxygen transmission through the film by approximately three orders of magnitude. Petroleum-based OPP is typically utilized for the base layers 112 118 because of its lower cost. A sealant layer 119 disposed upon the OPP layer 118 enables a hermetic seal to be formed at a temperature lower than the melt temperature of the OPP. The sealant layer 119 can be coextruded with the OPP layer 118. A lower melting point sealant layer 119 is desirable because melting the metalized OPP to form a seal could have an adverse effect on the barrier properties. Typical prior art sealant layers 119 include an ethylene-propylene co-polymer and an ethylene-propylene-butene-1 ter-polymer. A glue or laminate layer 115, typically a polyethylene extrusion, is required to adhere the outer base layer 112 with the inner, product-side base layer 118. Thus, at least two base layers of petroleum-based polypropylene are typically required in a composite or multi-layered film.

Other materials used in packaging are typically petroleum-based materials such as polyester, polyolefin extrusions, adhesive laminates, and other such materials, or a layered combination of the above.

FIG. 2 demonstrates schematically the formation of material, in which the OPP layers 112, 118 of the packaging material are separately manufactured then formed into the final material 100 on an extrusion laminator 200. The OPP layer 112 having graphics 114 previously applied by a known graphics application method such as flexographic or rotogravure is fed from roll 212 while OPP layer 118 is fed from roll 218. At the same time, resin for PE laminate layer 115 is fed into hopper 215a and through extruder 215b, where it will be heated to approximately 600° F. and extruded at die 215c as molten polyethylene 115. This molten polyethylene 115 is extruded at a rate that is congruent with the rate at which the petroleum-based OPP materials 112, 118 are fed, becoming sandwiched between these two materials. The layered material 100 then runs between chill drum 220 and nip roller 230, ensuring that it forms an even layer as it is cooled. The pressure between the laminator rollers is generally set in the range of about 0.5 to about 5 pounds per linear inch across the width of the material. The large chill drum 220 is made of stainless steel and is cooled to about 50-60° F., so that while the material is cooled quickly, no condensation is allowed to form. The smaller nip roller 230 is generally formed of rubber or another resilient material. Note that the layered material 100 remains in contact with the chill drum 220 for a period of time after it has passed through the rollers, to allow time for the resin to cool sufficiently. The material can then be wound into rolls (not specifically shown) for transport to the location where it will be used in packaging. Generally, it is economical to form the material as wide sheets that are then slit using thin slitter knives into the desired width as the material is rolled for shipping.

Once the material is formed and cut into desired widths, it can be loaded into a vertical form, fill, and seal machine to be used in packaging the many products that are packaged using this method. FIG. 3 shows an exemplary vertical form, fill, and seal machine that can be used to package snack foods, such as chips. This drawing is simplified, and does not show the cabinet and support structures that typically surround such a machine, but it demonstrates the working of the machine well. Packaging film 310 is taken from a roll 312 of film and passed through tensioners 314 that keep it taut. The film then passes over a former 316, which directs the film as it forms a vertical tube around a product delivery cylinder 318. This product delivery cylinder 318 normally has either a round or a somewhat oval cross-section. As the tube of packaging material is pulled downward by drive belts 320, the edges of the film are sealed along its length by a vertical sealer 322, forming a back seal 324. The machine then applies a pair of heat-sealing jaws 326 against the tube to form a transverse seal 328. This transverse seal 328 acts as the top seal on the bag 330 below the sealing jaws 326 and the bottom seal on the bag 332 being filled and formed above the jaws 326. After the transverse seal 328 has been formed, a cut is made across the sealed area to separate the finished bag 330 below the seal 328 from the partially completed bag 332 above the seal. The film tube is then pushed downward to draw out another package length. Before the sealing jaws form each transverse seal, the product to be packaged is dropped through the product delivery cylinder 318 and is held within the tube above the transverse seal 328.

Petroleum-based prior art flexible films comprise a relatively small part of the waste produced when compared to other types of packaging. Because the petroleum films are environmentally stable, petroleum based films have a relatively low rate of degradation. Consequently, discarded packages that become inadvertently dislocated from waste streams can appear as unsightly litter for a relatively long period of time. Further, such films can survive for long periods of time in a landfill. Another disadvantage of petroleum-based films is that they are made from oil, which many consider to be a limited, non-renewable resource. Consequently, a need exists for a biodegradable flexible film made from a renewable resource and/or from a recycled material. In one embodiment, such film should be food safe and have the requisite barrier properties to store a low moisture shelf-stable food for an extended period of time without the food staling. The film should have the requisite sealable and coefficient of friction properties that enable it to be used on existing vertical form, fill, and seal machines. Further, the film should reduce the amount of petroleum-based polyolefins required to make the film.

### SUMMARY OF THE INVENTION

One embodiment of the present invention is directed towards a multi-layer film for a package having barrier properties wherein one or more layers comprises paper made from post-consumer recycled fiber. In one aspect, the multi-layer packaging film of the present invention has an outer layer comprising a paper comprising post-consumer recycled fiber, an adhesive layer adhered to the outer layer, and a product side layer having barrier properties. The present invention thereby provides a multi-layer film with barrier properties that is made, at least in part, from recycled resources. Further, in one embodiment, at least a portion of the film is biodegradable. In one embodiment, the laminate layer comprises a polymer having a desirable flow characteristic such that the application of pressure and heat provided by the sealing jaws during the sealing can cause a thinning of the thickness of the laminate film in areas where more layers are present and a thickening of the thickness of the laminate film in the adjacent area where there are fewer layers as the polymer flow within the laminate layer moves laterally. Such embodiment minimizes or eliminates the capillary void space resulting in a paper-based food container with acceptable barrier properties that provides a high degree of sealability with the use of less petroleum-based polyolefins. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a cross-section of an exemplary prior art packaging film;

FIG. 2 depicts the exemplary formation of a prior art packaging film;

FIG. 3 depicts a vertical form, fill, and seal machine that is known in the prior art;

FIG. 4a depicts a magnified schematic cross-section of a multi-layer packaging film made with recycled materials according to one embodiment of the invention;

FIG. 4b depicts an exaggerated top cross-section of the intersection of the three layers of laminate packaging films in accordance with one embodiment of the present invention.

FIG. 4c depicts a magnified schematic cross-section of a multi-layer packaging film made with recycled materials according to one embodiment of the invention;

FIG. 5a depicts a magnified schematic cross-section of a multi-layer packaging film made with recycled materials according to one embodiment of the invention;

FIG. 5b is a prior art exaggerated top cross-sectional view of a sealed package that demonstrates the problem areas on a fill seal bag where pinhole leaks tend to occur; and

FIG. 6 depicts a magnified schematic cross-section of a multi-layer packaging film made with recycled materials according to an alternative embodiment of the invention.

### DETAILED DESCRIPTION

The present invention is directed towards use of a bio-based film comprising recycled material as at least one of the film layers in a multi-layer flexible film packaging. As used herein, the term “bio-based film” means a polymer film made from a non-petroleum or biorenewable feedstock. In one embodiment, the present invention is directed towards a flexible film comprising an outer paper layer comprising post consumer reclaim (“PCR”) fibers. As used herein the term “PCR fibers” refers to fibers that are made from recycled paper. As used herein, the term “PCR paper” refers to paper made from a cellulose-based material that comprises PCR fibers.

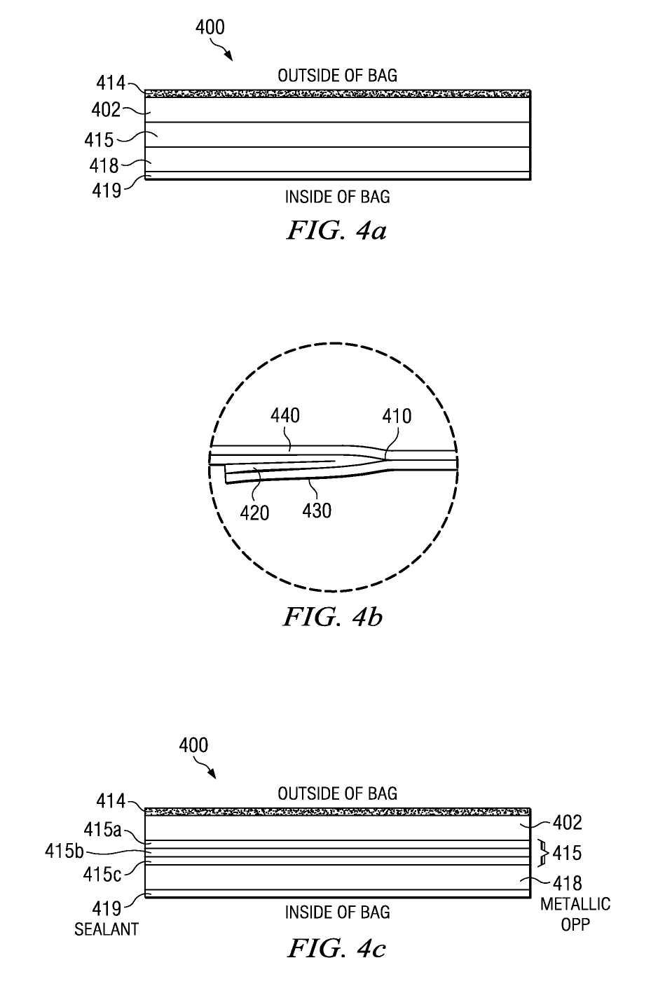

FIG. 4a depicts a magnified schematic cross-section of a multi-layer packaging film 400 made with recycled materials according to one embodiment of the invention. The multi-layer film 400 depicted in FIG. 4a is a hybrid film because it comprises both a biodegradable, bio-based film comprising recycled materials in the form of PCR paper 402 and a stable, metalized OPP film 418, Examples of metalized OPP films 418 having a sealant layer 419 that can be used in accordance with the present invention include pWX-2, PWX-4, PWS-2 films available from Toray Plastics of North Kingstown, R.I. or MU-842, Met HB, or METALLYTE films available from Exxon-Mobil Chemical.

In the embodiment shown in FIG. 4a, the outer base layer 402 comprises PCR paper. In one embodiment, the outer base layer 402 comprises food-safe PCR paper. As used herein, “food-safe PCR paper” is defined as the absence of any harmful or deleterious materials (such as ‘fluorescent whitening agents’) that can migrate to food products from recycled papers used for food packaging. U.S. Food and Drug Administration regulation 21 CFR 176.260 prohibits the presence of any harmful or deleterious materials that can migrate to food products from recycled papers used for food packaging. Food-safe PCR paper can be made from recycled paper-based feedstocks, as illustrated by U.S. application Publication No. 2005/0194110 and U.S. Pat. Nos. 6,294,047 and 6,387,211. Any reference in this specification to “PCR paper” is meant to also explicitly encompass “food safe PCR paper.”

In one embodiment, the outer base layer 402 comprises PCR paper which further comprises between about 5% and about 100% PCR fiber by weight of the outer base layer 402.

PCR paper fibers can be added to the virgin paper fibers during typical and conventional paper making processes during the wet mixing stage. The PCR fibers or PCR and virgin fibers are dried across a drum roll to form the paper sheet. The PCR fibers thereby replace a portion of all of the virgin fibers. Further, in one embodiment, the present invention comprises a multi-layer film 400 comprising PCR paper, wherein the multi-layer film 400 comprises between about 1.25% and about 70% PCR fibers by total weight of the multi-layer film 400.

Unlike plastic sheets of film where the thickness of the film is measured in “gauge”, the thickness of paper is measured in pounds per ream and refers to the weight of 432,000 square inches of film. In one embodiment, the outer base layer 402 comprises between about 15 pounds and about 30 pounds per ream. In one embodiment, the PCR paper comprises between about 25% and about 70% and more preferably about 50% by weight the laminate film 400.

A sheet of PCR paper can be processed like most thermoplastic polymers into a multi-layer film. For example, in one embodiment, the PCR paper is sent to a converter for printing and lamination. Referring again to FIG. 4a, a graphic image 414 is printed on the outer-facing of the outer base layer 402. Printing can take place via any number of conventional printing processes (flexographic, rotogravure, off-set, etc.). One problem with recycled paper films is that such films have poor moisture barrier and oxygen barrier properties. As a result, such films cannot currently be used exclusively in packaging low moisture shelf stable food products. Consequently, a laminate layer 415 can be used to “glue” the PCR paper sheet 402 to a metalized OPP film 418 or other barrier property layer having a sealant layer 419 with either conventional extrusion lamination (using molten polyethylene or similar material) or with adhesive lamination (either solvent or solvent-less).

In the embodiment shown in FIG. 4a, the inside sealant layer 419 can be folded over and then sealed on itself to form a tube having a fin seal for a backseal. The fin seal is accomplished by the application of heat and pressure to the film. Alternatively, a thermal stripe can be provided on the requisite portion of the PCR sheet 402 adjacent or on top of the graphics layer 414 to permit a lap seal to be used.

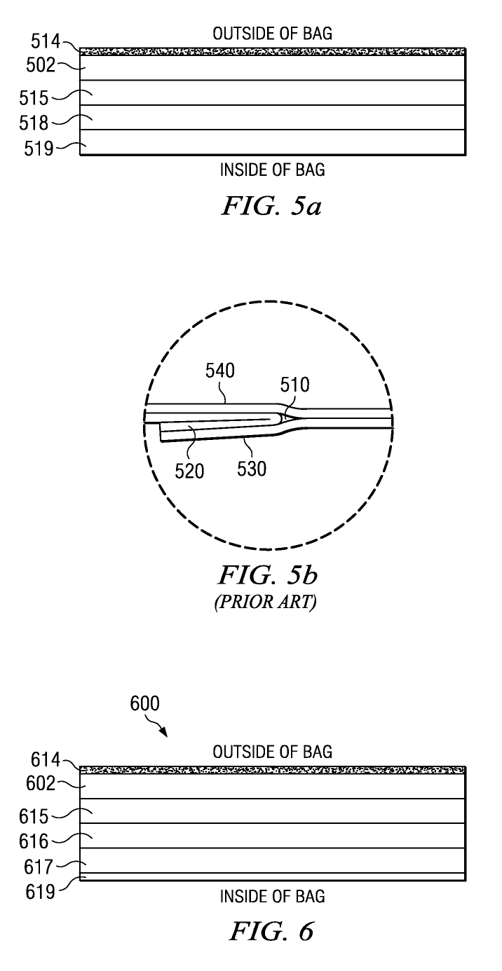

One problem with prior art fin seals is the void area that occurs as a result of the sealing at the location where the number of layers change. FIG. 5b is a prior art exaggerated top cross-sectional view of a sealed package that demonstrates the problem areas on a fin seal bag where pinhole leaks tend to occur. In this drawing, the areas near the back seal and the transverse are enlarged. As shown, the film tube comprises a first portion of film 520 sealed to a second portion of film 530 to form the fin seal. The fin seal is then sealed to an adjacent film 540 by the transverse sealing jaws, which creates the resultant triangular capillary area or void space 510. As can be seen in this enlargement, the immediate area where the number of layers changes is the most likely location for a leak. Such leak can be more prone in a laminate comprising a paper layer because of the properties of paper. One solution to this problem would be to use a thicker sealant layer. For example, referring to FIG. 5a, one may try to use a relatively thick 100 gauge (1 mil) polyethylene sealant layer 519 adjacent to a 70 gauge metalized OPP layer 518 that is glued with a 70 gauge polyethylene layer 515 to an outer paper layer 502 having a graphic image 514. While such embodiment can work, such embodiment defeats the purpose of using less petroleum-based polyolefin and instead runs the risk of merely adding a paper layer to a relatively thick plastic film sheet thereby using the substantially the same amount of oil-based polyolefin as used in the prior art petroleum based films in addition to a paper layer. For example, the above embodiment, would utilize approximately 2.4 mils of plastic.

Therefore to further enhance the present invention, in one embodiment, the laminate layer 415, as shown in FIG. 4a, comprises a polymer having a desirable flow characteristic such that the application of pressure and heat provided by the sealing jaws during the sealing can cause a thinning of the overall thickness of the film 400 in areas where more layers are present and a thickening of the thickness of the film 400 in the adjacent area where there are fewer layers. Such variable thickness is provided by lateral polymer flow within the laminate layer 415. As shown in FIG. 4b, the film tube comprises a first portion of film 420 sealed to a second portion of film 430 to form the fin seal. The fin seal is then sealed to an adjacent film 440 by the transverse sealing jaws. However, unlike the void space 510 shown in FIG. 5b, a laminate layer 415 comprising a polymer having a desirable flow characteristic minimizes or eliminates the capillary void space and creates an intersection 410 of film layers resulting in a paper-based food container having better sealability qualities with the use of less petroleum-based polyolefins. The reduction in pinhole leaks reduces or slows oxygen transmission from the outside environment to the food product, increasing product freshness and shelf life.

The desired flow characteristics of the laminate layer 415 can be achieved with the proper combination of melt index and/or the melting point of the polymer. The melt index is a reflection of the molecular weight of the material or the length of its hydrocarbon chains. The longer the hydrocarbon chains, the higher the molecular weight, the more viscous and tough the material, and the lower the melt index. As used herein a melt index is measured by ASTM D-1238, at 190° C. under a total load of 2.16 kg. As the melt index of a polymer increases, its ability to flow increases as well. Thus, in accordance with the present invention, the laminate layer 415 comprises a high melt index polymer. As used herein, a high melt index is defined as a polyolefin resin having a melt index of between about 10 dg/min and about 50 dg/min. Several types of polyolefin polymer or polyolefin resins have such a melt index and include, but are not limited to LDPE, resins, LLDPE resins, HDPE resins, and ethylene copolymers such as ethylene-acrylic acid, ethylene methyl acrylic acid, ethylene acrylate, methyl acrylate, ethyl acrylate, vinyl acetate, and mixtures thereof. Manufacturers of such materials include Dow Chemical, Eastman Chemical, CP Chemical, and Westlake. In one embodiment, the laminate layer 415 comprises a polyolefin resin having a melt index of between about 10 dg/min and about 50 dg/min. In one embodiment, the laminate layer 415 comprises a polyolefin resin having a melt index of greater than about 13 dg/min. In one embodiment, the laminate layer 415 comprises a polyolefin resin having a melt index of less than about 20 dg/min.

In addition to melt index, a polymer having a lower melting point causes the polymer in the laminate layer 415 to flow earlier, which can facilitate lateral flow toward the void space and/or help to minimize required dwell times when sealing the laminate film. Thus, in one embodiment of the present invention, the laminate layer 415 comprises a melting point of between about 60° C. and about 140° C.

The melting point of a polymer resin can be lowered by polymerization and the amount the melting point is lowered can be dependent upon the copolymer type or catalyst type that is used. Metallocene polyolefins are homogenous linear and substantially linear ethylene polymers prepared using single-site or metallocene catalysts. It is known that polyolefins made from supported metallocene catalyst systems tend to result in a polymers having a lower melting point than would otherwise be obtained if the metallocene were not supported. Consequently, in one embodiment of the present invention, the laminate layer 415 comprises a metallocene polyolefin obtained by the copolymerization of an ethylene including HDPE or LLDPE with an alpha olefin such as 1-butene, 1-hexene, and 1-octene.

The amount of a polymer used in a laminate can be defined by the coating weight. As used herein, the coating weight is the weight of the polymer applied per unit area of application. In one embodiment, the laminate layer 415 comprises a high melt index polymer having a coating weight of between about 1 and about 14 pounds per ream. In one embodiment, the laminate layer 415 comprises a high melt index polymer having a coating weight of between about 4 and about 8 pounds per ream. In one embodiment, the laminate layer 415 comprises a high melt index polymer wherein the high melt index polymer is greater than about 0.1 mils thick. In one embodiment, the laminate layer 415 comprises a high melt index polymer wherein the high melt index polymer is less than about 1.0 mils thick. In one embodiment, the laminate layer 415 comprises a high melt index polymer between about 0.2 and about 0.6 mils thick.

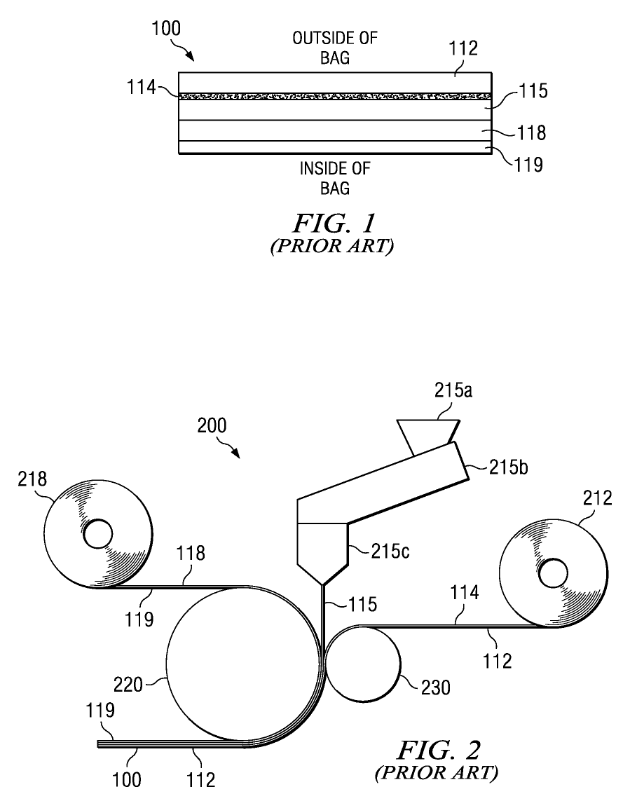

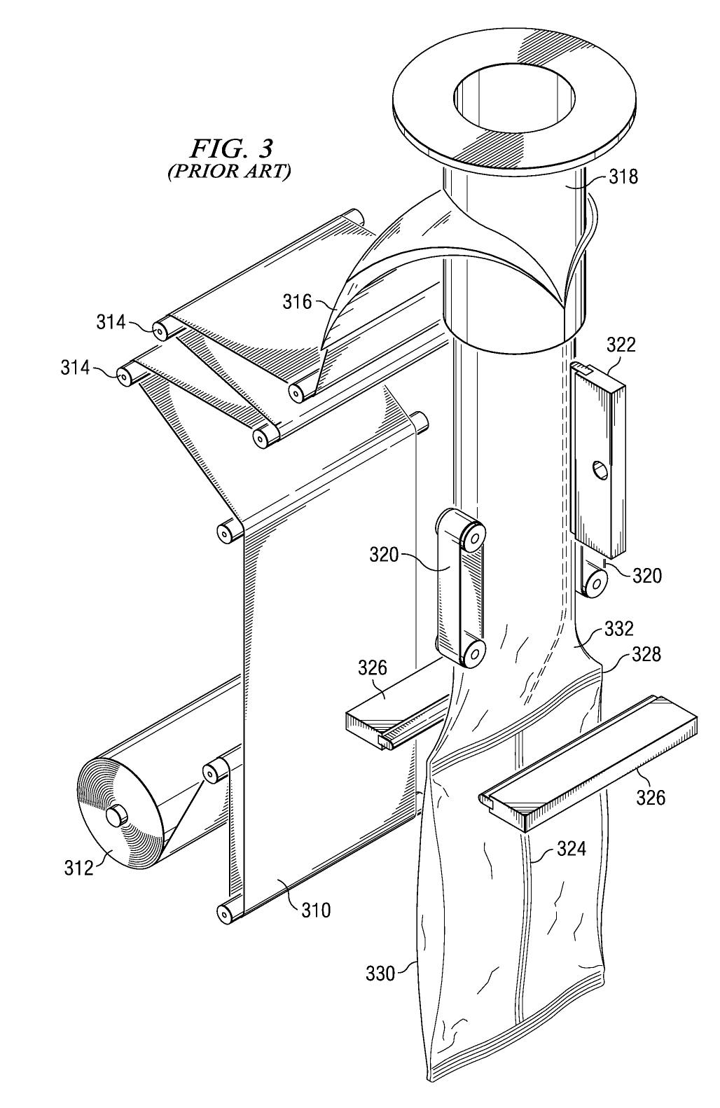

FIG. 4c depicts a magnified schematic cross-section of a multi-layer packaging film made with recycled materials according to one embodiment of the invention. In one embodiment, the proper combination of melt index and melting point can be provided by one or more polymer layers 415a 415b 415c within the laminate layer 415. For example, in one embodiment, the laminate layer 415 comprises a three layer co-extruded film having a high flow resin 415b or middle layer sandwiched between two layers 415a 415c. In one embodiment, the layers 415a 415c comprise low density polyethylene. As used herein, a high flow resin corresponds to a resin having a high melt index. Using multiple layers permits the laminator to coextrude a high flow resin with a more extrusion stable material so that the packaging film can be manufactured efficiently while delivering the desired mobility and movement of the laminate layer 415 during sealing. Such mobility and movement can provide a variable thickness where the number of layers change and are sealed together while minimizing the overall thickness of the petroleum-based polyolefin films.

Whereas the prior art outside film 112, laminate layer 115 and inner base layer 118 (as shown in FIG. 1) roughly were each one-third of the package film by weight, in one embodiment, the multi-layer film 400 of the present invention comprises an outside PCR paper 402 (as shown in FIG. 4a and FIG. 4c) of 50% by weight of the multi-layer film 400. Consequently, less OPP film can be used than is required in the prior art reducing consumption of fossil fuel resources.

In one embodiment, the total thickness of polyolefin films used in the laminate layer 415, and in the metalized OPP layer 418 and sealant layer 419 is less than 2.0 mils and more preferably less than about 1.5 mils. For example, referring to FIG. 4a, in one embodiment, the laminate layer 415 comprises a thickness of about 70 gauge, and the metalized OPP layer 418 and sealant layer combined comprises a thickness of about 70 gauge, resulting in a total polyolefin thickness of about 1.4 mils.

In one embodiment, the present invention provides a film comprising PCR paper wherein the film has between 25% and 70% less polyolefins than prior art films yet comprises acceptable oxygen and moisture barrier properties. As used herein, a film having acceptable oxygen barrier properties has an oxygen transmission rate of less than about 150 cc/m²/day (ASTM D-3985). As used herein, a film having acceptable moisture barrier properties comprises a water vapor transmission rate of less than about 5 grams/m²/day (ASTM F-1249). As used herein, a barrier property layer comprises a film having acceptable moisture and oxygen barrier properties and includes, but is not limited to metalized polyolefins and barrier films and layers disclosed in U.S. patent application Ser. No. 11/464,331, assigned to the same assignee as the present invention, and hereby incorporated by reference.

There are several advantages provided by the film having PCR paper in accordance with the present invention. First, the film can be produced using the same existing capital assets that are used to make prior art films. Second, in one embodiment, the film having PCR paper uses about 50% less petroleum by weight than the prior art film depicted in FIG. 1. Third, because the film is made from PCR paper at least a portion of the film is made from a renewable resource (paper originates from trees) and at least a portion of the paper is sourced from recycled material. Fourth, unlike petroleum-based films, PCR paper easily degrades. PCR paper is made up of cellulose molecules, which can be degraded through hydrolytic degradation (upon exposure to water), oxidative degradation (upon exposure to oxygen), and thermal degradation (upon exposure to heat). All of these sources of degradation are available in the open environment. Consequently, one benefit of the present invention is that the amount of unsightly litter degrades more quickly.

FIG. 6 depicts a magnified schematic cross-section of a multi-layer packaging film 600 made with recycled materials according to an alternative embodiment of the invention. Such multi-layer packaging film can advantageously be used in vertical stand-up packages having a bottom gusset because of the heavier sealant layer 619. The outer layer 602, having a graphic image 614 printed thereon, comprises PCR paper and in one embodiment comprises food-safe PCR paper. The PCR paper 602 is adhered with a laminate layer 615 to a middle barrier layer 616 which is adhered via a polyethylene or other suitable laminate layer 617 to a sealant layer 619. In one embodiment, the middle barrier layer 616 comprises a metalized OPP. The sealant layer 619 can comprise a cast or blown metallocene-catalyzed polyethylene/polypropylene or other suitable sealant layer 619 can be used. The inside sealant layer 619 can be folded over and then sealed on itself to form a tube having a fin seal for a back seal. The fin seal is accomplished by the application of heat and pressure to the film. Alternatively, a thermal stripe can be provided on the requisite portion of the bio-based film 602 to permit a lap seal to be used.

The present invention provides numerous advantages over traditional, petroleum-based prior art films. First, the present invention reduces consumption of fossil fuels because a PCR paper is being used for one or more layers of the film that previously required a petroleum-based/fossil-fuel based polypropylene polymer. Consequently the film of the present invention is made with a renewable or recycled resource.

Second, the present invention lowers the amount of carbon dioxide in the atmosphere because the origin of the PCR paper is plant-based. Although the paper-based film can degrade in a relatively short period of time under composting conditions, if the film is placed into a landfill the carbon dioxide is effectively sequestered away and stored because of the lack of light, oxygen, and moisture available to degrade to the film. Thus, the carbon dioxide that was pulled from the atmosphere by the plant from which the PCR paper was derived is effectively placed into storage. Further, if the PCR paper comprises more than 80% of PCR fiber by weight, more carbon dioxide is sequestered from the atmosphere than is used to make the PCR paper. Consequently, the present invention can be used to provide a carbon dioxide sink for greenhouses gases.

Third, less litter is visible because a portion of the film making up the resultant package is biodegradable. As used herein, the term “biodegradable” means that less than about 5% by weight and preferably less than about 1% of the film remains after being left at 35° C. at 75% humidity in the open air for 60 days. Those skilled in the art will understand that at different ambient conditions, it may take longer for the film to degrade. By comparison, an OPP film can last more than 100 years under these same conditions.

As used herein, the term “package” should be understood to include any container including, but not limited to, any food container made up of multi-layer thin films. The sealant layers, thin films, and films with a high melt laminate layer as discussed herein are particularly suitable for forming packages for snack foods such as potato chips, corn chips, tortilla chips and the like. However, while the layers and films discussed herein are contemplated for use in processes for the packaging of snack foods, such as the filling and sealing of bags of snack foods, the layers and films can also be put to use in processes for the packaging of other foods. While this invention has been particularly shown and described with reference to a preferred embodiment, it will be understood by those skilled in the art that various changes in form and detail may be made therein without departing from the spirit and scope of the invention.

What is claimed is:

1. A package comprising a multi-layer film, said multi-layer film comprising:
an outer layer comprising a PCR paper;
a laminate layer adjacent to said outer layer; and
a product side sealant layer comprising a metalized polyolefin layer.

2. The package of claim 1 wherein said PCR paper comprises a food safe PCR paper.

3. The package of claim 1 wherein said multi-layer film further comprising a polyolefin thickness of less than about 2.0 mils.

4. The package of claim 1 wherein said PCR paper comprises at least 25% of said multilayer packaging film by weight.

5. The package of claim 1 wherein said PCR paper further comprises a graphic image.

6. The package of claim 1 wherein said PCR paper comprises about a thickness between of about 15 pounds and about 30 pounds per ream.

7. The package of claim 1 wherein said PCR paper comprises between about 5% and about 100% PCR fiber by weight.

8. The package of claim 1 wherein said PCR paper comprises between about 25% and about 70% PCR fiber by weight of said multi-layer film.

9. The package of claim 1 wherein said laminate layer comprises a polyolefin resin having a melt index of between about 10 dg/min and about 50 dg/min.

10. The package of claim 1 wherein said laminate layer adjacent said outer layer comprises a first laminate layer and said multi-layer film comprises a second laminate layer between said sealant layer and said metalized polyolefin layer.

11. A multi-layer film comprising:
a layer of PCR paper, said PCR paper comprising between about 5% and about 100% PCR fibers;
a first laminate layer joining said PCR paper and a barrier property layer comprising barrier properties wherein said barrier property layer comprises an oxygen transmission rate of less than about 150 cc/m²/day and a water vapor transmission rate of less than about 5 gram s/m²/day, and wherein said barrier property layer further comprises a sealant layer.

12. The film of claim 11 wherein said PCR paper comprises a food safe PCR paper.

13. The film of claim 11 wherein said multi-layer film further comprising a total polyolefin thickness of less than about 2.0 mils.

14. The film of claim 11 wherein said PCI paper comprises at least 25% of said multilayer packaging film by weight.

15. The film of claim 11 wherein said PCR paper further comprises a graphic image.

16. The film of claim 11 wherein said PCR paper comprises about a thickness between of about 15 pounds and about 30 pounds per ream.

17. The film of claim 11 wherein said PCR paper comprises between about 5% and about 100% PCR fiber by weight.

18. The film of claim 11 wherein said PCR paper comprises between about 25% and about 70% PCR fiber by weight of said multi-layer film.

19. The film of claim 11 wherein said laminate layer comprises a polyolefin resin having a melt index of between about 10 dg/min and about 50 dg/min.

20. The film of claim 11 further comprising a second laminate layer between said sealant layer and said barrier property layer.
